(19) United States
(12) Patent Application Publication
(10) Pub. No.: US 2008/0008196 A1
(43) Pub. Date: Jan. 10, 2008

(54) Heterogenous Network Interworking Method of a Node Having Multiple Network Interfaces

(75) Inventor: Yong Geun Hong, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 11/722,243

(22) PCT Filed: Oct. 12, 2005
(86) PCT No.: PCT/KR05/03405

§ 371 Date: Jun. 20, 2007

(30) Foreign Application Priority Data
Dec. 20, 2004 (KR) 10-2004-0108917

(51) Int. Cl. H04L 12/28

(52) U.S. Cl. 370/401

(57) ABSTRACT

Provided is a heterogeneous network interworking method for a mobile node having multiple network interfaces. When the mobile node moves from a first network to a second network, the method includes transmitting a packet via a first network interface at the first network, before moving to the second network, by setting up a simple IP address, which is a fixed address of the mobile node, as a sender's address in an inner header of the packet, and an IP address assigned actually to the first network interface as a sender's address in an external header; and transmitting a packet via a second network interface at the second network, after moving to the second network, by setting up said simple IP address as a sender's address in the inner header of the packet and an IP address assigned actually to the second network interface as a sender's address in the external header. In other embodiment, the method includes generating a virtual network interface; and adjusting a flow of packet in a link layer so as to make a packet passing through the multiple network interfaces to be transferred to a mobile IP layer through the virtual network interface.

### BACKGROUND ART

1. Field of the Invention

The present invention relates to a heterogeneous network interworking mechanism adapted to enable a node having multiple network interfaces to connect to Internet while moving between different IP-based networks (for example, IPv4 and IPv6 networks).

2. Description of Related Art

In ubiquitous network environment, many services and various access technologies are mutually combined or integrated, to provide better and seamless services. Various services and technologies such as combination of wired and wireless communications, combination of broadcasting and communication etc. will be converged for a new concept of services, and this new concept of services will include all services from the current services to future services. These services will use an IP packet oriented network infrastructure. The ubiquitous network will provide communication and broadcasting services that are helpful and economical to users.

In order to provide convergence of various services, the combination of various different communication technologies is required. For example, the combination of 802.3 Ethernet communication technology and 802.11 WLAN communication technology, combination of WLAN and CDMA communications, the combination of WLAN, CDMA and Wibro (or High-speed Portable internet: HPi) communication technologies, and so forth may be required. Although WLAN technologies such as 802.11a, 802.11b and 802.11g are widely used to provide wireless data services until now, 3G communication technologies such as CDMA2000 1x, CDMA2000 EV DO and CDMA2000 EV DV are being established as important technologies of wireless data communication. The WLAN communication technology and the CDMA communication technology can be used as a complement to each other. The WLAN communication technology can guarantee a fast communication speed and a wide bandwidth within a hot spot area where WLAN service is possible, but it cannot provide any service outside the hot spot area. In the area outside the hot spot area, the CDMA communication technology, which has a slower Internet speed and a relatively narrower bandwidth, can provide Internet access service to users. Therefore, the combination of the WLAN and CDMA communication technologies allows users to make an access to Internet anywhere.

Current network mobility technology enables a node having a single network interface to be always connected to Internet and to get services of single link layer technology during moving between networks, using mobility support technology, such as a mobile IP.

FIG. 1 shows an existing interworking process when a node having a single network interface moves from one network to another network by using a mobile IP. The mobile IP employs two IP addresses, one of which is a home address, which is an inherent address that is not changed permanently, and the other is a care-of address (CoA) that can be changed according to a connected location. A mobile node (MN) has a constant home address at all times no matter which network it moves to and has a newly assigned CoA whenever it moves to a new network. Whenever getting a new CoA, the MN should inform the CoA to its own home agent (HA). The HA serves forwards a packet, which is forwarded to the home address, to a location at the new CoA through a tunnel. FIG. 1 shows an inter-working process when the MN having a single network interface moves from one network to another network by using a mobile IP. As shown, when moving from a network1 to a network2, the MN 110 maintains one network connection with a correspondent node (CN) 130 by using the same network interface eth0.

However, in order to provide a new concept of services and seamless Internet services, a node that has multiple network interfaces and uses various link sub-layer technologies is being emerged. Accordingly, it may cause many problems to apply the current technologies used in the single-interface node, without any modification, to a multiple-interface node. Specifically, the current mobility support technology cannot support a mobility of a multiple-interface node that moves between heterogeneous networks (for example, between WLAN and CDMA networks), which are based on different link-layer technologies. Thus, it is necessary to provide a new mechanism capable of supporting mobility of the node that has multiple network interfaces and moves between heterogeneous networks.

### SUMMARY OF THE INVENTION

The present invention is directed to a method for enabling interworking between heterogeneous networks when a node having multiple network interfaces moves between the heterogeneous networks using link sub-layer technologies.

One aspect of the present invention is to provide a heterogeneous network interworking method for a mobile node having multiple network interfaces, when the mobile node moves from a first network to a second network. The method comprises the steps of: transmitting a packet via a first network interface at the first network, before moving to the second network, by setting up a simple IP address, which is a fixed address of the mobile node, as a sender's address in an inner header of the packet, and an IP address assigned actually to the first network interface as a sender's address in an external header; and transmitting a packet via a second network interface at the second network, after moving to the second network, by setting up said simple IP address as a sender's address in the inner header of the packet and an IP address assigned actually to the second network interface as a sender's address in the external header.

Another aspect of the present invention is to provide a heterogeneous network interworking method for a mobile node having multiple network interfaces by using a mobile IP, when the mobile node moves between heterogeneous networks. The heterogeneous network interworking method comprises the steps of: generating a virtual network interface; and adjusting a packet flow in a link layer so as to make a packet passing through the multiple network interfaces to be transferred to a mobile IP layer through the virtual network interface.

Yet another aspect of the present invention is to provide a heterogeneous network interworking method for a mobile node having multiple network interfaces by using a mobile IP, when the mobile node moves between heterogeneous networks. The heterogeneous network interworking method comprises the steps of: selecting a network interface from the multiple network interfaces; and adjusting a flow of packets in a link layer so as to make a packet passing through the multiple network interfaces to be transferred to a mobile IP layer through the selected network interface.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 shows an existing internetworing process when a node having a single network interface moves from one network to another network by using a mobile IP;

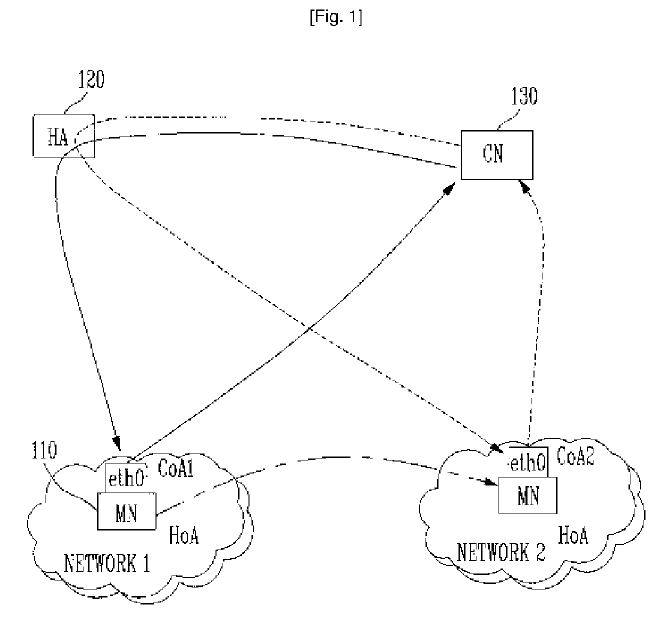

FIG. 2 shows a network interworking process using a simple IP and dynamic tunneling, when a mobile node moves from one network to another network (here, IP versions of the networks before and after the movement are equal to each other) in accordance with a first embodiment of the present invention;

FIG. 3 shows a network interworking process using a simple IP and dynamic tunneling from one network to another network (here, IP versions of the networks before and after the movement are different each other) in accordance with a first embodiment of the present invention;

FIGS. 4a and 4b show a network interworking process using a mobile IP when a mobile node moves from one network to another network (here, IP versions of the networks before and after the movement are equal to each other) in accordance with a second embodiment of the present invention;

FIG. 5 shows a network interworking process using a mobile IP when a mobile node moves to a network whose IP version is different from that of a network before the movement in accordance with a second embodiment of the present invention; and

FIG. 6 shows an example implementation of interworking between heterogeneous networks with respect to a mobile node having both a WLAN interface and a CDMA interface, in accordance with the present invention.

### DETAILED DESCRIPTION OF THE PREFERRED EMBODIMENTS

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure is thorough and complete and fully conveys the scope of the invention to those skilled in the art.

The present invention is directed to a method for providing Internet connectivity when a node having multiple network interfaces moves from one network to another network. To this end, the present invention proposes two schemes: (1) an interworking scheme using a simple IP address and dynamic tunneling and (2) an interworking scheme using a mobile IP. In addition, when the node having multiple network interfaces moves from one network to another network, an IP version of the networks may be different each other. There may be taken, as an example, the movement from an IPv4 (IPnterne version 4) network to an IPv6 (IP version 6) network, and vice versa. Further, the IP versions before and after movement may be equal to each other. Hereinafter, in consideration of each case, the interworking process between heterogeneous networks according to the present invention will be described in detail.

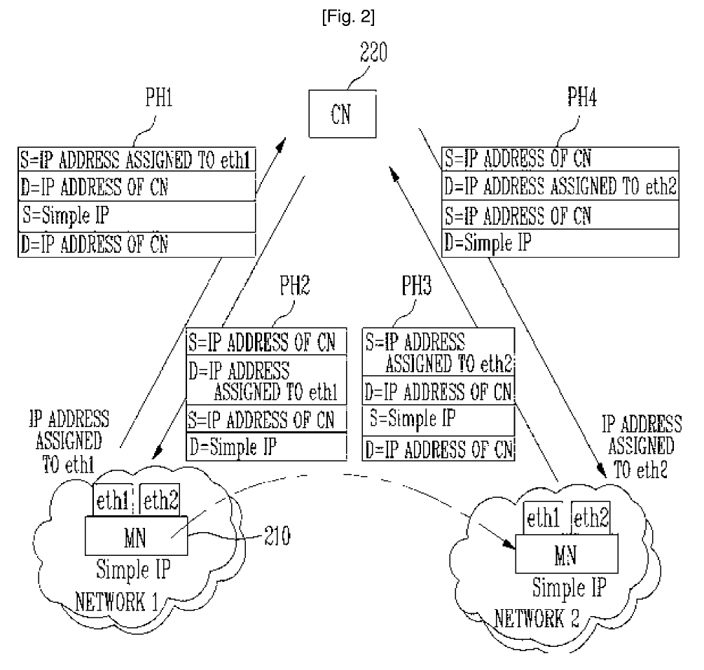

FIG. 2 shows a network interworking process using a simple IP and dynamic tunneling when a mobile node (MN) moves to a different network (here, IP versions of the networks before and after the movement are equal to each other) in accordance with a first embodiment of the present invention. Herein, the term, “simple IP address” which is used for discrimination from a mobile IP, means a static address that is assigned to a node from the beginning and is not changed during the traversal through the networks. In other words, the simple IP address is an IP address assigned when communication is initiated by an application program, and may be assigned in the communication-originated network, according to a stateless address auto-configuration mechanism, or may be pre-defined.

In FIG. 2, the MN 210 performs Internet connection through a network interface 1(eth1) in the Network 1. Here, as shown in a header structure (PH1) of the packet that is transmitted from the MN 210 to a correspondent node (CN) 220, the inner header of the packet transmitted to the CN 220 has the simple IP address as a sender' address and the IP address of the CN 220 as a receiver's address. When the packet passes through a network layer, an encapsulation process for adding an external header at the front of the inner header is performed. The external header includes the IP address that is actually assigned to the interface1 as the sender's address, and the IP address of the CN 220 as the receiver's address. When the packet generated in this manner is transmitted to the CN 220, the CN 220 decapsulates the external header and transmits the decapsulated packet to an application program. Thus, the application program (not shown) of the CN 220 recognizes the simple IP address of the MN and will use the simple IP address as the sender's address, when transmitting a packet to the MN. When the application program of the CN 220 intends to transmit a packet to the MN 210 by using the simple IP address, an external header, in which the IP address assigned actually to the interface1 of the MN 210 in the network layer is included as the receiver's address, will be encapsulated into the packet. The encapsulated packet is transmitted to the MN 210. A header structure of the packet transmitted from the CN 220 to the MN 210 is indicated by PH2 in the FIG. 2. Through such a interworking process, Internet-based communication is performed between the MN 210 in the Network 1 and the CN 220.

Thereafter, when the MN 210 moves to a Network 2, an IP address of the CN 220 is delivered from the Interface 1 to the Interface 2 during the movement.

After the movement, the MN 210 is assigned the IP address of the Interface 2 (eth2) in the Network 2. The IP address assigned to the Interface 2 (eth2) is transmitted to the CN 220. As for a header structure PH3 of a packet which the MN 210 transmits to the CN 220, it can be seen that an inner header of PH3 has the same sender's and receiver's addresses as those of the inner header of PH1, while an external header has an sender's address which is changed from the IP address assigned to the Interface 1 into that assigned to the Interface 2. In other words, even when the MN 210 moves to a new network (e.g. Network 2), the simple IP address of the inner header is not changed, but only the IP address assigned to an actual network interface of the external header is changed. For this reason, when being routed up to the CN 220, the packet can be transmitted to the CN by using the IP address that is assigned to the actual network interface. Further, when being delivered to the application program, the packet can be transmitted to the application program by using the simple IP address.

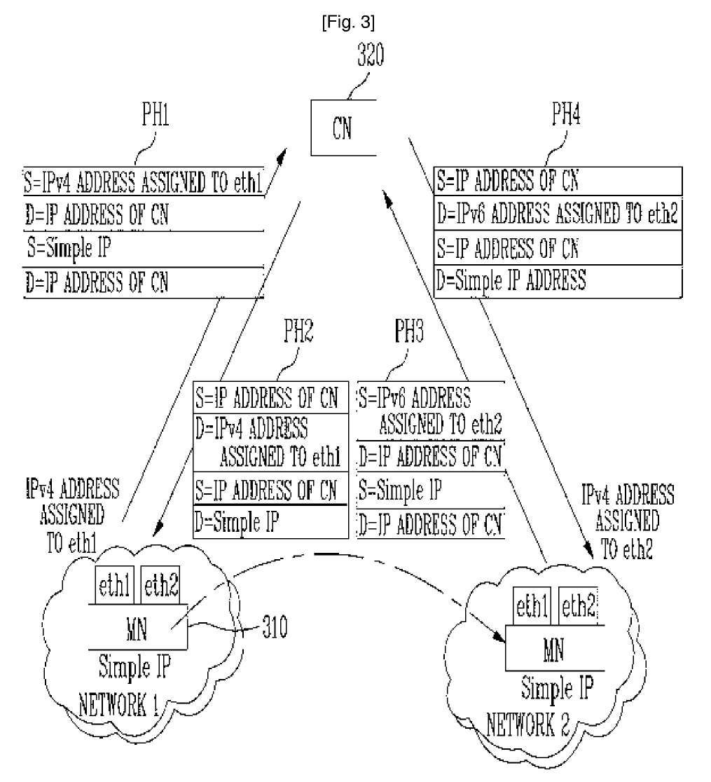

FIG. 2 shows the case where the networks before and after the movement of the MN are equal in IP version (e.g. IPv4-IPv4 or IPv6-IPv6) as mentioned above, while FIG. 3 shows the case where the networks before and after the movement of the MN are different in IP version. Nevertheless, the case where the networks before and after the movement of the MN are different in IP version has a packet processing similar substantially to the case when the networks before and after the movement of the MN are equal in IP version, except that the IP versions of the external headers are different when the IP packets before and after the movement are encapsulated.

FIG. 3 shows the case where a MN moves from IPv4-based network to IPv6-based network. As shown, it can be seen that, when the MN 310 is located in the Network 1, a sender's address of the external header of a packet (PH1) transmitted to a CN 320 includes an IPv4 address assigned to an Interface 1 (eth1). And it can be seen that, when the MN 310 is located in the Network 2, a sender's address of an external header of a packet (PH3) transmitted to the CN 320 includes an IPv6 address assigned to an Interface 2 (eth2).

Now, a network interworking process according to a second embodiment of the present invention will be described. According to the second embodiment of the present invention, the internal flow of packets passing through multiple network interfaces is managed at a link layer level, by the use of a mobile IP, so that the packets can be always transmitted to an IP layer through a fixed network interface.

In existing application programs or communication programs, multiple network interfaces are adapted to operate as a single interface so as to use the mobile IP protocol. Thus, in order for the multiple interfaces to operate as a single interface, although the multiple network interfaces are actually being used, a virtual interface is established. Then, the packets passing through the multiple network interfaces can be transferred to the virtual interface by adjusting the internal packet flow at a link layer level. As another method for making the multiple network interfaces to operate as a single network interface, one network interface is selected from the multiple network interfaces and the packets passing through the other multiple network interfaces are transferred to the selected network interface by adjusting the internal packet flow at the link layer level.

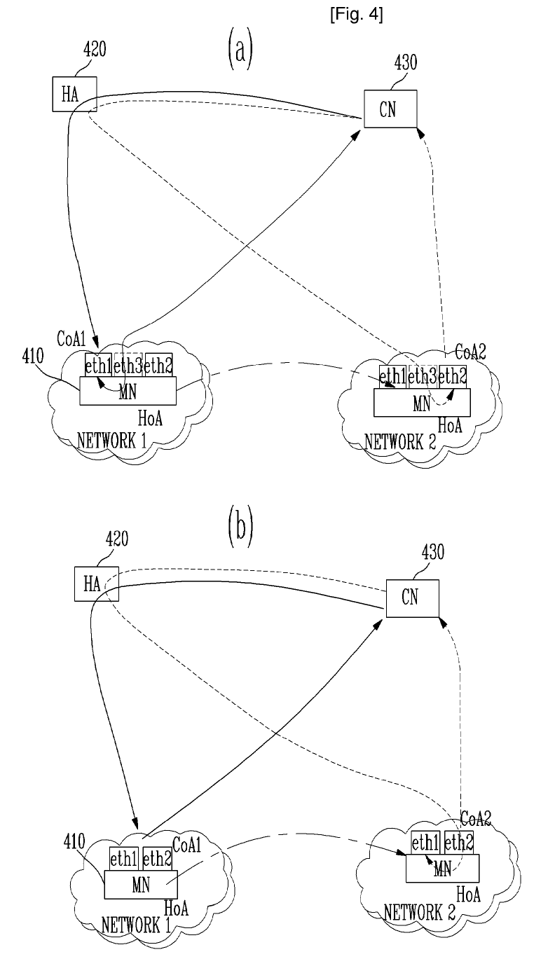

FIGS. 4a and 4b show a network interworking process using a mobile IP when a MN moves to a different network (here, the networks before and after the movement are equal in IP version) in accordance with a second embodiment of the present invention.

Referring to FIG. 4a, there is shown the network interworking process using a virtual interface. As shown, a separate virtual interface eth3 is established such that two network interfaces eth1 and eth2 of a MN 410 can operate as a single interface. Accordingly, packets passing through the network interfaces eth1 and eth2 are adapted to be transferred to the virtual interface eth3 by adjusting the internal packet flow at a link layer level.

Referring to FIG. 4b, there is shown the network interworking process using a specific interface selected from multiple network interfaces. The embodiment shown in FIG. 4b shows the case where a network interface1 eth1 is selected. In transferring packets passing through the multiple network interfaces to the mobile IP layer, the process of FIG. 4b is different only in that, instead of separately establishing the virtual interface, any one of the multiple network interfaces is selected, and is substantially similar in detailed operation, as compared with that of FIG. 4a.

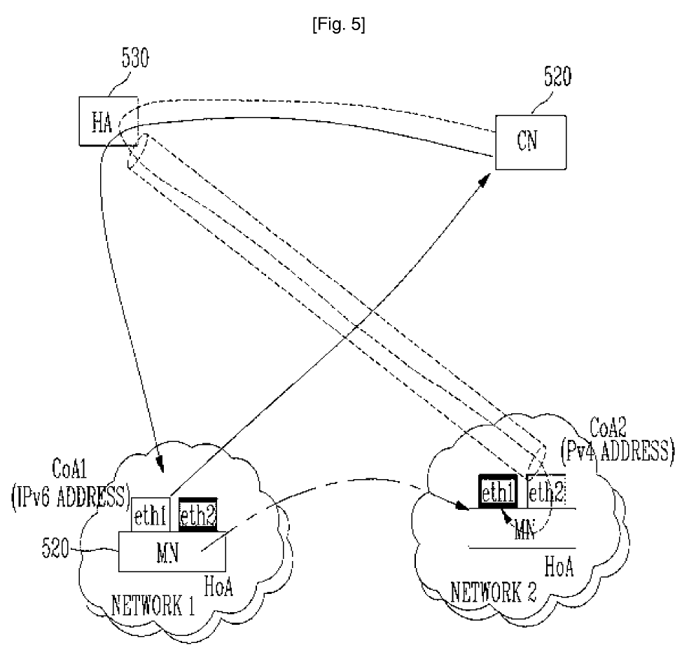

FIG. 5 shows a network interworking process using a mobile IP when a MN moves to a network whose IP version is different from that of a network before the movement in accordance with a second embodiment of the present invention. With regard to a technique of using a mobile IP when the IP versions of the networks before and after the movement are different from each other, because a mobile IPv4 and a mobile IPv6 are different protocols, a tunneling between IPv4 and IPv6 is generated such that a packet from one mobile IP can pass through the network using the other mobile IP.

The embodiment shown in FIG. 5 is applied to the case where a MN 510 moves from an IPv6 network to an IPv4 network. As shown, after the MN 510 moves from the IPv6 network to the IPv4 network, an IPv6-in-IPv4 tunneling is generated between a home agent (HA) 530 and a network interface2 eth2 such that a mobile IPv6 packet can be routed to an IPv4 network.

A packet processing between a network interface eth1 before the movement and a tunneled interface eth2 is similar to those described in connection with FIGS. 4a and 4b. To be specific, in order for the multiple interfaces to operate as a single interface, a separate virtual interface is established and multiple network interfaces are connected thereto, or any one of the multiple network interfaces is selected. The internal packet flow is adjusted at a link layer level such that packets passing through the other network interfaces can be transferred to a newly generated tunneling interface through the selected network interface.

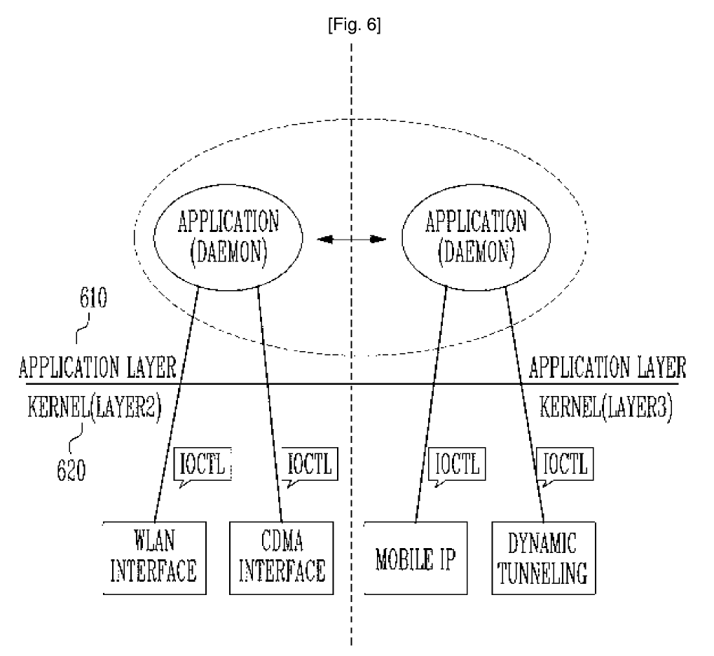

FIG. 6 shows an exemplary implementation of interworking between heterogeneous networks with respect to a MN having both a WLAN interface and a CDMA interface in accordance with the present invention. The example is implemented based on a Linux. The program codes for performing an internetworking process may be divided into an application program layer 610 and a kernel 620. A link layer for handling network interfaces and an IP layer for handling a mobile IP and tunneling process may execute in the kernel 620 and a user' application program may execute in the application program layer 610. Communications between the application layer 610 and the kernel 620 may be performed by using ioctl provided by the Linux. As shown, the program codes of the link layer for handling network interfaces such as CDMA and WLAN interfaces (shown at the left side of FIG. 6) and those of the IP layer for handling a mobile IP and tunneling (shown at the right side of FIG. 6) can be separately implemented.

According to the present invention, when a node having multiple network interfaces moves between heterogeneous networks, it is possible to provide Internet connection at all times during the movement. As various wireless access technologies emerge, the MN having the multiple network interfaces can get seamless communication services at all times when moving between heterogeneous networks and between networks having different IP versions.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention

1. A heterogeneous network interworking method for a mobile node having multiple network interfaces, wherein the mobile node moves from a first network to a second network, the method comprising the steps of:
transmitting a packet via a first network interface at the first network, before moving to the second network, by setting up a simple Internet protocol (IP) address, which is a fixed address of the mobile node, as a sender's address in an inner header of the packet, and an IP address assigned actually to the first network interface as a sender's address in an external header; and
transmitting a packet via a second network interface at the second network, after moving to the second network, by setting up said simple IP address as a sender's address in the inner header of the packet and an IP address assigned actually to the second network interface as a sender's address in the external header.

2. The heterogeneous network interworking method according to claim 1, wherein said IP address set up as the sender's address in the external header is based on an IP version of the network where the mobile node is currently located.

3. The heterogeneous network interworking method according to claim 1, wherein the correspondent node receiving the packet from the mobile node transfers the packet to an application program after decapsulating the external header of the packet.

4. The heterogeneous network interworking method according to claim 1, wherein the correspondent node transmits a packet to the mobile node, by setting up the simple IP address of the mobile node as a receiver's address in the inner header of the packet and the IP address assigned actually to the first network interface as a receiver's address in the external header of the packet, before the mobile node moves to the second network; and by setting up the simple IP address of the mobile node as the receiver's address in the inner header of the packet and the IP address assigned actually to the second network interface of the mobile node as the receiver's address of the external header, after the mobile node moves to the second network.

5. A heterogeneous network interworking method for a mobile node having multiple network interfaces by using a mobile IP, wherein the mobile node moves from a first network to a second network, the method comprising the steps of:
generating a virtual network interface; and
adjusting a flow of packet in a link layer so as to make a packet passing through the multiple network interfaces to be transferred to a mobile IP layer through the virtual network interface.

6. A heterogeneous network interworking method for a mobile node having multiple network interfaces by using a mobile IP, wherein the mobile node moves from a first network to a second network, the method comprising the steps of:
selecting a network interface from the multiple network interfaces; and
adjusting a flow of packets in a link layer so as to make a packet passing through the multiple network interfaces to be transferred to a mobile IP layer through the selected network interface.

7. The heterogeneous network interworking method according to claim 5, when IP versions used in the first and second networks are different from each other, the method includes the step of generating a tunnel between a home agent in the first network and the network interface used in the second network, so as to make a packet transferred to the home agent to be routed to the second network, after the mobile node moves to the second network.

8. The heterogeneous network interworking method according to claim 6, when IP versions used in the first and second networks are different from each other, the method includes the step of generating a tunnel between a home agent in the first network and the network interface used in the second network, so as to make a packet transferred to the home agent to be routed to the second network, after the mobile node moves to the second network.
